(19) United States
(12) Patent Application Publication
(10) Pub. No.: US 2022/0212958 A1
(43) Pub. Date: Jul. 7, 2022

(54) GRAPHENE OXIDE NANOCOMPOSITES AS GRANULAR ACTIVE MEDIA

(71) Applicant: Graphene Leaders Canada (GLC) Inc., Edmonton (CA)

(72) Inventor: Leah Shawn COUMONT, Edmonton (CA)

(21) Appl. No.: 17/425,866

(22) PCT Filed: Jan. 24, 2020
(86) PCT No.: PCT/CA2020/050091

§ 371 Date: Jul. 26, 2021

Related U.S. Application Data
(60) Provisional application No. 62/797,034, filed on Jan. 25, 2019.

(51) Int. Cl. C02F 1/28; B01J 20/20; B01J 20/32; B01J 20/28; B01J 20/30; B01J 20/06

(52) U.S. Cl. CPC C02F 1/288; B01J 20/205; B01J 20/321; B01J 20/3212; B01J 20/2805; C02F 2101/20; B01J 20/06; B01J 20/3085; B01J 20/3242; C02F 1/283; B01J 2220/46; B01J 20/3021

(57) ABSTRACT

A granular carbon nanocomposite adsorbent which has a surface active material that is suitable for adsorbing contaminants in a liquid, and a carrier material. At least a portion of the surface active material is a graphene nanomaterial. The carrier material carries the surface active material as the surface active material interacts with the contaminants. The carrier material and surface active material are formed into granules.

### TECHNICAL FIELD

This relates to using graphene oxide as adsorbent media for the removal of contaminants from a liquid, and in particular, graphene oxide embedded within granular solid material.

### BACKGROUND

In recent years, a global initiative has been undertaken to better control water quality, ensuring adequate clean water for society, and maintaining a healthy global ecosystem. While many methods exist for the treatment of contaminated and naturally non-potable waters, these methods can be too costly and technologically demanding to be applied on a large scale. As such, more efficient, versatile and tailorable methods of water treatment are required that can treat very large volumes of effluent, require low energy input, and can be reused to avoid generation of massive amounts of secondary waste.

Recently, numerous approaches have been studied for the development of cheaper and more effective technologies, both to decrease the amount of wastewater produced and to improve the quality of the treated effluent. Though many methods and materials exist for the removal of heavy metals from water, a universal solution has not been found that is sufficiently fast, inexpensive, and effective to be able to reduce the concentration of contaminants such as selenium, mercury and chromium in surface waters and effluent streams to an acceptably low level. In these cases, adsorbents offer an excellent alternative to traditional wastewater treatment systems such as flocculation, chemical treatment, electrophoretic separation, or membrane-based separation methods. While many benefits to adsorption are evident for water treatment, some challenges have yet to be overcome such as finding methods to tune the surface of the adsorbents such that they will adsorb the desired contaminants, and not suffer reductions in efficiency from competing adsorbates present in the effluents. A growing field of development dedicated to improving adsorbent selectivity involves the preparation of nanocomposite-based adsorbent media. Using this strategy, selective adsorbents have been developed for a number of contaminants of concern. Included in this body of materials are those based on graphene oxide (GO), and GO composite materials, which have shown excellent performance for adsorption-based water treatment but are typically based on either coatings of existing filtration materials, which are not sufficiently robust for large scale water treatment, or magnetic separation, which may involve high energy input to separate and redisperse the magnetic adsorbents.

The use of graphene oxide and graphene oxide/iron oxide nanocomposites as adsorbents has been well documented in the patent literature. For example, graphene materials may be used in the removal of heavy metals including selenium from waste water in the form of magnetite/graphene oxide nanoparticles in magnetic filtration, examples of which are described in PCT publication no. WO2016172755A1 (Tabor et al.) entitled “Non-covalent magnetic graphene oxide composite material and method of production thereof” and PCT publication no. WO2014094130A1 (Fu et al.) entitled “Graphene oxide for use in removing heavy metal from water”. Additionally, metal oxide nanoparticles alone, or coated onto the surface of activated carbon have also been investigated for the adsorption of various contaminants including selenium, an example of which is described in PCT publication no. WO2011016038A1 (Semiat et al.) entitled “Method for removal of selenium contaminants from aqueous fluids”.

### SUMMARY

According to certain aspects, there are provided methods for preparing granular adsorbents from graphene nanomaterials through incorporation of graphene oxide into an organic or inorganic solid matrix for the removal of contaminants from liquid, such as water. The methods may be used to generate composites containing graphene oxide materials, with particles of sufficient size that the composites may be easily handled and deployed using conventional continuous flow or batch liquid treatment methods such as open or closed filters, or columns. The methods for preparing the nanocomposite materials may include the preparation of graphene oxide/metal oxide nanocomposites including goethite, titanium and zirconium oxides, which may be used as a granular material, or may be incorporated into polymer-based beads through phase inversion following co-dispersion into polymer solutions in organic solvents. These materials may be used in the adsorption of heavy metals, selenium, arsenic, and other organic or inorganic contaminants. These same materials may also act as catalysts as well as adsorbents, where contaminants adhere to the graphene composite surface and then undergo a chemical reaction to modify their toxicity, solubility, or otherwise alter their chemical nature to reduce potential damage to the environment, or human or animal health. The methods may also be used in the deployment of composite materials in, for example, a column for continuous flow, or loose macro-scale adsorbent bead for batch-type deployment. The nanocomposites may be regenerated for further use in subsequent adsorption experiments.

According to an aspect, there is provided a granular carbon nanocomposite adsorbent, comprising a surface active material that is suitable for adsorbing contaminants in a liquid, where at least a portion of the surface active material comprises a graphene nanomaterial. A carrier material carries the surface active material as the surface active material interacts with the contaminants, the carrier material and surface active material being formed into granules.

According to other aspects, the granular carbon nanocomposite adsorbent may include one or more of the following features, alone or in combination: the carrier material may comprise a metal oxide, a polymer, or combinations thereof; the graphene nanomaterial may comprise graphite nanoplatelets, graphene, graphene oxide, graphite oxide, reduced graphene oxide, graphene nanocomposites, or combinations thereof; the graphene nanomaterial may be chemically functionalized to include one or more amine group, one or more carboxylate group, one or more sulfonate group, or combinations thereof; the surface active material may act as a catalyst on at least some of the adsorbed contaminants; the granular carbon nanocomposite adsorbent may comprise between 5% and 90% graphene nanomaterial by weight and between 10 and 95% metal oxide component by weight; the granules may be generated in-situ by reacting metal precursors to generate metal oxide in the presence of the graphene nanomaterials, and the metal oxide may comprise the solid carrier material; the carrier material may be a polymer, and the surface active material may be incorporated into the polymer through phase inversion from a liquid co-dispersion in a polymer/solvent solution, and the polymer may comprise polyvinylchloride, polypropylene, polyethylene, or nylon, and the surface active material may be between 1 and 12.5% by weight, and the polymer may be between 87.5 and 99% by weight; the carrier material and the surface active material may be stable in water; at least a portion of the surface active material may be added by manual blending or grinding with the carrier material prior to being formed into granules; the granules may be provided in a water permeable container, and the water permeable container may be a flow-through container, or may be placed within a body of water to be treated.

According to an aspect, there is provided a method of treating a liquid, comprising the steps of: providing carbon nanomaterial adsorbents as described above; deploying the granules in the liquid such that the granules contact the carbon nanomaterial adsorbents with liquid contaminated by heavy metals, metalloids, organic contaminants, or combinations thereof; causing the carbon nanomaterial adsorbents to adsorb at least a portion of the contaminants; and retrieving the granules from the liquid.

According to other aspects, deploying the granules may comprise placing the granules in a water permeable container, and may further comprise flowing water through the water permeable container, or placing the water permeable container in a body of water to be treated.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of granules in a flow through container.

FIG. 2 is a schematic view of granules in a passive container.

### DETAILED DESCRIPTION OF PREFERRED EMBODIMENTS

Of the many methods available to treat water, adsorption is suited to the treatment of trace contaminants as the mechanism of action involves the physicochemical interaction of the contaminant of concern and the surface of a solid material, and given adequate mixing, will allow sorption to occur at the surface even in very dilute conditions. This interaction may be reversible or irreversible, and helps to determine the ultimate fate of the contaminant once it is removed from water, which may include disposal to a landfill, being stripped from the surface in the form of a concentrate, or having the contaminant undergo some form of chemical reaction at the surface to generate less-harmful by-products. Which process occurs is determined by both the nature of the contaminant and the surface to which it is appended. For this reason, in this document the term “surface-active material” will be used to denote a material that primarily adsorbs contaminants, and may also act as a catalyst, to remove contaminants from the water being treated. The surface-active material is combined with a carrier material that allows the surface active material to be useful under various operating conditions. As adsorption is a more common mechanism, the discussion below may be given in terms of adsorbing materials. However, it will be understood that similar principles may be used with catalytic materials.

It will also be understood that, while the present materials and methods are primarily discussed and developed in terms of treating water to remove contaminants, the surface active materials and composites discussed herein may also be selected to remove contaminants from other liquids aside from water.

The nanocomposite material is made up of surface active material, and carrier materials that are preferably selected to be stable, or sufficiently stable to interact with contaminants in the intended environment. For example, in water, the surface-active and carrier materials should resist dissolution, or should allow the nanocomposite material to maintain a solid or particulate form in water. The nanocomposite materials preferably have an overall granular form and be comprised of both a surface active material, and a carrier material that gives the adsorbent a macroscopic form and may or may not contribute to the adsorption process. Here, the term “granular form” refers to any shape that has a size smaller than, for example, about 1 cm in effective diameter. The size of the granular form may vary, depending on the preferences of the user and the circumstances of the intended use. In general, smaller granules are preferred in order to increase the surface area of the active material exposed to the liquid, while still being large enough to easily handle while being added to and removed from the liquid. The surface active material may be a nanomaterial, or nanocomposite itself, which is at least partly composed of a nanomaterial component. The size of the nanomaterial component may vary depending on the particular circumstances, however it is preferred that, to be classified as a nanomaterial, a minimum of one dimension of the constituent particles is less than 100 nm. In this application, the nanomaterial is preferably a carbon nanocomposite. A carbon nanocomposite is a more specific type of nanocomposite and generally refers to a mixture of a carbon-based material such as graphite, graphene nanoplatelets, graphene, graphene oxide, reduced graphene oxide, or combinations thereof with another material, typically a nanomaterial itself. The form of carbon material that is preferable in the application described herein is graphene oxide on the basis of its chemical structure, and low-cost relative to other similarly functionalized carbon nanomaterials. The carrier material of the carbon nanocomposite is preferably selected to offer a robust chemical structure having the overall properties of bonding well to the carbon-based material, and remain structurally resistant to the operating conditions including high levels of agitation if necessary.

Graphene is a unique material formed from a single atomic layer of sp₂ hybridized carbon. Graphene materials may be single, double or multiple layers thick. Multiple layers of graphene stacked on top of one another are well known as graphite. Typically, graphene is considered to have less than 10 atomic layers, while graphite and graphene nanoplatelets are considered to have more than 10 atomic layers. Despite the similarities in structure and composition, the properties of graphene differ significantly from graphite. For example, graphene has superior lubricity properties compared to graphite, and is more flexible. Owing to the 2-dimensional structure and chemical bonding, graphene possesses incredible strength, electronic and heat conduction properties, and high charge carrier mobility. Graphene has potential applicability in the fields of nanoelectronics, energy storage materials, polymer composite materials, and sensing technologies.

Graphene oxide is an oxidized derivative of graphene that is formed through the aqueous exfoliation of graphite oxide. Graphite oxide may be synthesized through numerous well-established methods such as the Staudenmeier method, the Hoffmann method, and the Hummers method, including the modified Hummers method, starting from graphite flake. The oxidation process typically involves simultaneous intercalation and functionalization of the graphite to generate a product that is easily dispersed to generate freestanding flakes of 2D material (graphene oxide) with a surface rich in oxygen functional groups.

The process of chemical oxidation of graphite introduces oxygen rich functional groups to the surface of the graphene oxide, such as epoxide, lactone, and carboxylate groups. As this imparts the resultant graphene oxide with a negative surface charge in water, this may be beneficial when used in aqueous environments. This chemical identity not only delivers an environment conducive to form complexes with heavy metals, but also acts as a chemical handle that may be used to form covalently modified graphene materials appended to small molecules, polymers, and branched compounds. This flexibility in chemical functionalization allows the chemical properties of the material to be tuned through modification of charge, and availability of certain functional groups with a given affinity for certain compounds or ions, to target any number of contaminants for adsorption-based water treatment. Additionally, the chemical nature of the functionalized graphene oxide may also be modified to act as catalysts to break down contaminants present in water or other liquid environments.

One strategy for targeted adsorption of trace contaminants in water may include the functionalization of graphene oxide with inorganic nanoparticles. In this regime, metal oxide nanoparticles that have known utility in water treatment as surface active materials are used to form nanocomposites with graphene oxide. Using this methodology imparts the surface active materials with properties that may not be seen in the bulk inorganic material such as selectivity, bond strength, high surface area to volume ratios, and magnetic properties. In addition to direct formation of nanoparticles on the GO surface, the graphene oxide may also be chemically functionalized first to include one or more amine group, one or more carboxylate group, one or more sulfonate group, or combinations thereof. In doing so, the graphene oxide may be rendered useful to a larger range of chemistries, which can alter the interaction between the graphene oxide and metal oxide nanoparticles to further tailor the surface properties. Similar considerations may be used when used in other liquid environments. While nanoparticulate strategies employing graphene oxide nanocomposites are effective, they often introduce a secondary problem in subsequent removal of the material from the treated water, which can involve either magnetic removal of the nanomaterials, or time consuming nanofiltration.

In certain examples, the effectiveness of the graphene oxide adsorbent may be tailored by functionalizing the graphene oxide with alternative functional groups that can change the reactivity to target different contaminants. This functionalization process may occur by reacting the graphene oxide with small molecules or polymers containing functional groups that will bind to the epoxy, carboxylate, alcohol or carbonyl groups on the surface of the graphene oxide such as amines, chlorosilanes or methoxysilanes, diazonium salts, and hydroxides. Aside from the reactive group which attaches to the GO surface, the remainder of the molecule may be selected in such a way to target contaminants of choice including organic contaminants, inorganic contaminant, pharmaceuticals, and perfluorinated compounds. This functionalized graphene may then be added to the granular surface-active media as discussed above for application to water treatment.

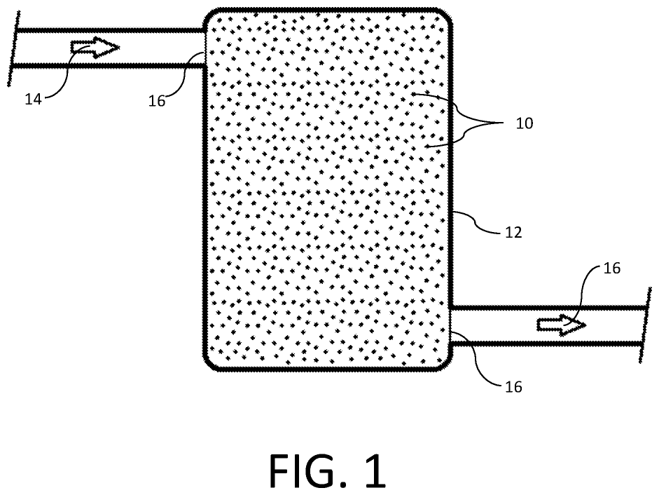

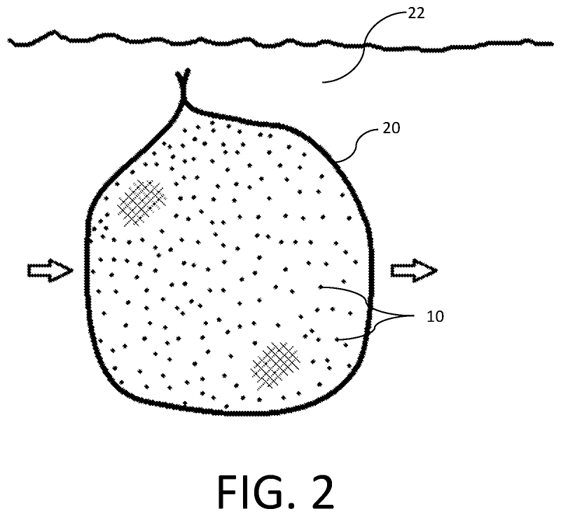

To make use of the surface-active properties of the graphene nanomaterial, such as graphene oxide and carbon nanocomposites, while alleviating the difficulty in safely handling and recovering the nanomaterials prior to and following liquid treatment, the surface active materials may be incorporated into macroscale granular composites wherein the surface active material is embedded within a matrix composed of either an inorganic oxide material or organic polymer. In doing so, the process generates materials that may be relatively easy to handle, and may be easily applied to liquid treatment when packed into a flow-through column 12 as shown in FIG. 1, held in a water permeable container 20 that may be made from rigid or flexible material as shown in FIG. 2, or used as a loose adsorbent that may be placed in a body of water or other liquid to be treated, then recovered using simple filtration or skimming. Other options may be used when treating water or other liquids in other environments.

Referring to FIG. 1, flow-through column 12 is shown packed with granules 10. A fluid flow 14 is able to flow through column 12 to be treated by granules 10. As shown, flow-through column 12 may be provided with water permeable barriers 16 that allow fluid to enter and exit column 12 while holding granules 10. Referring to FIG. 2, a water permeable container 20 filled with granules 10 is shown placed in a body of water 22 that is to be treated. In this case, the body of water may be passively treated by the granules held within water permeable container 20 as water within body of water 20 passes through permeable container 20. As shown, water permeable container 20 is made from a flexible material, however other permeable materials may be used.

The surface active material may be embedded within the carrier material to form a nanocomposite- as defined above- using different mechanisms. In some examples, a physical or mechanical process may be used, while in others a chemical process may be used. In other examples, the carrier material may be a polymer, and the adsorbent material may be incorporated into the polymer through phase inversion from a liquid co-dispersion in a polymer/solvent solution. Suitable examples of polymers may include polyvinylchloride, polypropylene, polyethylene, nylon, etc. Depending on the preferences of the intended use, and the carrier material, there may be between 5% and 90% graphene nanomaterial by weight, and between 10 and 95% carrier material by weight in the case of a metal oxide, or between 1 and 12.5% graphene nanomaterial by weight, and between 87.5 and 99% polymer carrier by weight.

In other examples, the surface active material may be embedded within granules of carrier material by growing the matrix, or carrier, material in the presence of the graphene oxide, such as may occur through the reaction of compounds in solution that form a precipitate. In one example, the granular carbon nanocomposite may be generated in-situ by reacting metal precursors to generate metal oxide in the presence of the graphene nanomaterials, the metal oxide comprises the solid carrier material. Metal oxides are readily formed through the reaction of metal salts, such as sulfates, nitrates, and halogenides under basic conditions, typically in water, to generate metal hydroxides and metal oxide products. The interaction between the metal oxide and graphene oxide may be a simple physical entrapment within the growing granules of metal oxide, or more commonly will involve the formation of chemical bonds between the metal and graphene surface which will assist in giving the material added strength, and may also help build upon beneficial synergistic interactions such as enhancements to the selectivity (bonding surface), and adsorption energy, as well as interactions which may influence the fate of the adsorbed contaminant such as the strength and mechanism of bonding, and the energy required to induce chemical change.

In this document, the surface active material, which may be a graphene nanomaterial, and most preferably graphene oxide or a graphene oxide nanocomposite, may also be subjected to additional processing to generate a functional material depending upon the specific end application of the material. For example, one application may require that the material have buoyant characteristics and be easily floated atop an effluent stream and then collected in which case a larger, polymer-based particle may be required. In another application, in which the material is packed within a column or fluidized bed, buoyancy may not be a target, so as such it may be ideal to grind the composite such that the granule size is small and surface area to volume ratio is maximized. In one example, graphene oxide may be mixed with the matrix, or carrier material, such as by manual blending or grinding, and then formed into granules using known approaches, such as melting, compressing, using adhesives, etc. In those examples, the carrier material may be in a powder or other suitable form. In other examples, the carrier material may be a liquid that is then formed into granules.

In the example where a polymer loaded sample may be produced, the surface active material may be embedded using a variety of mechanisms. In some embodiments, a physical or mechanical process may be used, while in others a chemical process may be used. In other examples, the carrier material may be a polymer, and the surface active material may be incorporated into the polymer through phase inversion from a liquid co-dispersion in a polymer/solvent solution. Suitable examples of polymers may include polyvinylchloride, polypropylene, polyethylene, nylon, etc. which dissolve readily in solvents that are compatible with the surface active materials, can be made very structurally robust while holding a granular shape, and do not dissolve in aqueous media.

Once it is produced, the adsorbent medium can be applied to liquid treatment by housing it within an appropriate container to allow exposure of the surface active materials to the liquid to be treated. This may include any type of liquid permeable container ideally suited to each individual application. For example, a container for the adsorbent prepared from a rigid porous material may be better suited to fixed or higher-pressure applications such as a column bolted onto an existing water treatment chain. In an alternative application, involving passive treatment, adsorbent could be loaded into a porous cloth bag which could then be deployed into a contaminated liquid source.

In one example, a graphene oxide goethite granular adsorbent is prepared through the reaction of a coordination compound of iron in either a +2 or a +3 oxidation state in a basic aqueous graphene oxide dispersion. Following heating to 90° C. until the solid turns to a dark brown colour, the reaction mixture is cooled to room temperature and then filtered under suction and washed to yield a brown solid which can then be crushed to a given mesh size. The adsorbing abilities of the material were demonstrated in batch experiments by soaking the adsorbent in selenium solutions for 24 hours over a range of solution pH from 2 to 8, demonstrating selenium removal of up to 100% for both selenite and selenate under some conditions. The adsorption capacity was determined by measuring the equilibrium selenium removal over a range of concentrations from 0.1-500 ppm, and demonstrates that the adsorption capacity is 19 mgse/gadsorbent for both selenite, and selenate. Kinetics experiments performed by exposing the adsorbent to 300 ppb selenium solutions show that adsorption processes are rapid (equilibrium established in <1 hr). The ability to use the material under continuous flow conditions was tested through the construction of a prototype column. The column was prepared by taking a 50 mm×4.6 mm stainless steel tube with fritted filters on each end with a pore size of 1.8 um, fitted to the end of the column with stainless steel Swagelok fittings. The column was packed with an adsorbent by transferring the maximum amount of composite to the tube. The packing was then completed by tapping and vibrating the column on a vortex mixer at which time more composite was added to fill the void space, yielding a column containing a total of 0.7g of the nanocomposite. Selenium adsorption on the surface was accomplished by passing 500 ppm selenate solution through the column at a flow rate of 1 ml/min, and the effluent collected and tested. The column was then regenerated by flushing with aqueous NaOH in a concentration of 0.01-1M, followed by aqueous HC1 in a concentration of 0.01-1M. The results show consistent selenium removal through repeated cycles of selenium adsorption followed by regeneration of the surface over 20 times.

In other examples, graphene oxide or graphene oxide-metal oxide nanocomposites are ground to a fine powder and dispersed in a suitable organic solvent. In a second container, a solution matrix polymer in the same organic solvent is prepared and the 2 solutions combined and homogenized to form a thick black dispersion. This dispersion is then used to prepare adsorbent beads by dropping from a pipette, syringe or automated dropper into a miscible antisolvent, and left to cure for a predetermined period of time. The solid beads are then collected from the curing bath by filtration through a screen and dried for a minimum of 24 hours before use. Once completed, the solid adsorbent may be in the form of spherical beads with a porous surface containing channels in the surface that are on the order of 10s of um in diameter. The granular beads may then be deployed in either column or batch deployments, such as those shown in FIG. 1 and FIG. 2, respectively, to remove heavy metals and organic contaminants from water or other liquids. In one example, a suitable bead material was observed to remove up to 113 mg/g of Pb⁺². Regeneration of the active surface can also be accomplished using a mild chemical solution, and the adsorbents reused to adsorb more heavy metals from water or other liquids.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

1. A granular carbon nanocomposite adsorbent, comprising:
a surface active material that is suitable for adsorbing contaminants in a liquid, where at least a portion of the surface active material comprises a graphene nanomaterial; and
a carrier material that carries the surface active material as the surface active material interacts with the contaminants, the carrier material and surface active material being formed into granules.

2. The granular carbon nanocomposite adsorbent of claim 1, where the carrier material comprises a metal oxide, a polymer, or combinations thereof.

3. The granular carbon nanocomposite adsorbent of claim 1, where the graphene nanomaterial comprises graphite nanoplatelets, graphene, graphene oxide, graphite oxide, reduced graphene oxide, graphene nanocomposites, or combinations thereof.

4. The granular carbon nanocomposite adsorbent of claim 1, where the graphene nanomaterial is chemically functionalized to include one or more amine group, one or more carboxylate group, one or more sulfonate group, or combinations thereof.

5. The granular carbon nanocomposite adsorbent of claim 1, where the surface active material acts as a catalyst for at least some of the adsorbed contaminants.

6. The granular carbon nanocomposite adsorbent of claim 1, comprising between 5% and 90% graphene nanomaterial by weight, and between 10 and 95% metal oxide component by weight.

7. The granular carbon nanocomposite adsorbent of claim 1, where the granules are generated in-situ by reacting metal precursors to generate metal oxide in the presence of the graphene nanomaterials, and the metal oxide comprises the solid carrier material.

8. The granular carbon nanocomposite adsorbent of claim 1, where the carrier material is a polymer, and the surface active material is incorporated into the polymer through phase inversion from a liquid co-dispersion in a polymer/solvent solution.

9. The granular carbon nanocomposite adsorbent of claim 8, where the polymer comprises polyvinylchloride, polypropylene, polyethylene, or nylon.

10. (canceled) .

11. The granular carbon nanocomposite adsorbent of claim 8, where the surface active material is between 1 and 12.5% by weight, and the polymer is between 87.5 and 99% by weight.

12. The granular carbon nanocomposite adsorbent of claim 1, where at least a portion of the surface active material is added by blending or grinding with the carrier material prior to being formed into granules.

13. The granular carbon nanocomposite adsorbent of claim 1, comprising a water permeable container for the granules, and the water permeable container being made from a rigid or flexible material.

14. (canceled)

15. A method of treating a liquid, comprising the step of:
providing carbon nanomaterial adsorbents, the carbon nanomaterial adsorbents comprising surface active materials that are suitable for adsorbing contaminants in a liquid, where at least a portion of the adsorbent materials comprise graphene nanomaterials, and a carrier material that carries the surface active materials as the surface active materials interact with the contaminants, and the carrier materials and surface active materials being formed into granules;
deploying the granules in the liquid such that the granules contact the carbon nanomaterial adsorbents with liquid contaminated by heavy metals, metalloids, organic contaminants, or combinations thereof; and
causing the carbon nanomaterial adsorbents to adsorb at least a portion of the contaminants; and
retrieving the granules from the liquid.

16. The method of claim 15, where the carrier material comprises a metal oxide, a polymer, or combinations thereof.

17. The method of claim 15, where the graphene nanomaterial comprises graphite nanoplatelets, graphene, graphene oxide, graphite oxide, reduced graphene oxide, graphene nanocomposites, or combinations thereof.

18. The method of claim 15, where the graphene nanomaterial is chemically functionalized to include one or more amine group, one or more carboxylate group, one or more sulfonate group, or combinations thereof.

19. The method of claim 15, where the surface active material acts as a catalyst for at least some of the adsorbed contaminants.

20. The method of claim 15, where the carbon nanomaterial adsorbent comprises between 5% and 90% graphene nanomaterial by weight, and between 10 and 95% metal oxide component by weight.

21. The method of claim 15, further comprising the step of generating the granules in-situ by reacting metal precursors to generate metal oxide in the presence of the graphene nanomaterials, and the metal oxide comprises the solid carrier material.

22. The method of claim 15, where the carrier material is a polymer, and the surface active material is incorporated into the polymer through phase inversion from a liquid co-dispersion in a polymer/solvent solution.

23. The method of claim 22, where the polymer comprises polyvinylchloride, polypropylene, polyethylene, or nylon.

24. The method of claim 22 where the surface active material is between 1 and 12.5% by weight, and the polymer is between 87.5 and 99% by weight.

25. (canceled)

26. The method of claim 15, where at least a portion of the surface active material is added by blending or grinding with the carrier material prior to being formed into granules.

27. The method of claim 15, where deploying the granules comprises placing the granules in a water permeable container.

28. The method of claim 27, further comprising the step of flowing water through the water permeable container, or placing the water permeable container in a body of water to be treated.
